(19) United States
(12) Patent Application Publication
(10) Pub. No.: US 2008/0296799 A1
(43) Pub. Date: Dec. 4, 2008

(54) Methods and Devices for the Production of Solid Filaments in a Vacuum Chamber

(76) Inventors: Manfred Faubel, Rosdorf (DE); Ales Charvat, Gottingen (DE); Jurgen Troe, Gottingen (DE); Bernd Abel, Dransfeld (DE); Eugene Lugovoi, Gottingen (DE)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 10/585,833

(22) PCT Filed: Jan. 14, 2005
(86) PCT No.: PCT/EP2005/000333

§ 371 Date: Aug. 11, 2008

(30) Foreign Application Priority Data
Jan. 26, 2004 (DE) 10 2004 003 854.6

(51) Int. Cl. B29C 35/10

(52) U.S. Cl. 264/166; 425/72.1

(57) ABSTRACT

Disclosed are methods for producing a solid filament from a liquid in a vacuum chamber, comprising the following steps: a gas is liquefied in a heat exchanger apparatus to produce the liquid; and the liquid is delivered into the vacuum chamber via a supply duct and through a nozzle. Liquefying of the gas in the heat exchanger apparatus encompasses adjusting a p-T operating point of the liquid at which the liquid is transformed into the solid aggregate state and forms a collimated and stable jet after being discharged from the nozzle into the vacuum chamber. Also disclosed are nozzle arrangements for producing solid filaments in a vacuum.

The invention relates to methods for the production of solid filaments by supplying a liquid, especially a liquefied gas into a vacuum chamber, with the features of the preamble of Claim 1. The invention also relates to nozzle arrangements designed to carry out such methods, and to a radiation source with such a nozzle arrangement and with a vacuum chamber.

X-ray radiation sources are known in which a liquid target material is injected with a nozzle arrangement into a vacuum chamber where it is converted by laser irradiation into a plasma state in which material-specific X-ray fluorescence radiation is emitted. It is desirable that the target material supplied into the vacuum chamber forms a liquid jet or a solid filament (frozen liquid jet) with the greatest possible spatial stability and the lowest possible divergence. These requirements, that are mutually related, serve to increase the stability and reproducibility of the X-ray radiation generated at each laser irradiation. Moreover, there is interest in carrying out the laser irradiation with the greatest possible distance from the nozzle arrangement because ions and other rapid particles are also emitted from the plasma state of the target material that can result in an erosion of and damage to the nozzle.

The cited requirements are met with conventional X-ray radiation sources. Liquid jets have a certain decay length within which fluctuations in the liquid build up until the jet decays into drops. The decay length is a function of the surface tension of the liquid and its viscosity. Previously, the laser irradiation had to take place at a distance from the nozzle that was less than the decay length.

US 2002/0044629 A1 describes a nozzle arrangement for supplying liquefied xenon into a vacuum chamber. The nozzle arrangement comprises a nozzle heating with which undesired deposits of the target material on the nozzle that disadvantageously influence the flow form are to be avoided. This technology does improve the reproducibility of the flow formation. However, there is the disadvantage that the target material is not influenced by the nozzle heating so that even instabilities or fluctuations in the flowing target material cannot be reduced. The material flowing in does not form a stable jet but rather a flow section that decays after a short travel into drops or a spray. For example, if the liquid material flowing into the vacuum chamber freezes, a flow section of solid material forms that decays after a short time and forms a spray. Therefore, the technology described in US 2002/0044629 A1 has limited effectiveness and the focus of the laser irradiation must be localized closely to the nozzle.

The cited instabilities in the flowing target material occur in particular in X-ray radiation sources whose liquid target material is formed by a condensation of a gas. The condensation takes place in a heat exchanger like the one described, e.g., in EP 1 182 912 A1 or WO 02/085080 A1. Conventionally used heat exchangers typically have a condensation container whose walls are cooled with a cooling medium such as e.g., liquid nitrogen. A formation of bubbles and retardation of boiling occur in a connected nitrogen reservoir as well as in the liquefaction in the condensation container. As a consequence, oscillations that are transferred to the exiting jet or even interruptions of the jet are caused. However, such interruptions are unacceptable for the use, e.g., of X-ray radiation sources in practice for which an interruption-free running time of hours or days is required.

If the heat exchanger operates with an evaporation cooler whose compressor is directly connected mechanically to the nozzle (see, e.g., WO 02/085080 A1), instabilities can also be caused in the flowing target material by oscillations emanating from the compressor.

The cited problems occur not only in conventional X-ray radiation sources but also in other applications of thin liquid jets as target for physical and chemical investigations in a high vacuum such as, e.g., in the generation of EUV radiation or in the coupling of technical or medical sample liquids to mass spectrometers. There is also interest in these instances in compact jet injection systems that operate reliably and are maintenance-friendly.

The objective of the invention is to provide improved methods for producing solid filaments in a vacuum chamber with which the disadvantages of the conventional techniques are overcome. The objective consists in particular in providing methods with which solid filaments can be produced from liquefied gases with increased stability in time and space. Furthermore, the filaments should be characterized as being free from interruption and having an increased directional stability (or: reduced divergence). Another partial aspect of the objective of the invention is that the method should be compatible with available radiation sources or mass spectrometers and should have an expanded application range as concerns the gases that can be supplied into the vacuum. The invention also has the objective of providing improved nozzle arrangements with which the disadvantages of the conventional arrangements can be overcome and that are especially suitable for an injection of target material that is stable in time and space and for a long-lasting production of long filaments, especially of liquefied gases in a high vacuum. The nozzle arrangements of the invention should be suitable in particular for the injection of different target materials or be able to be readily adapted for the supplying of different target materials.

These objectives are solved with methods and nozzle arrangements with the features according to Claims 1 or 17. Advantageous embodiments of the invention result from the dependent claims.

As concerns the method, the invention is based on the general technical teaching that in order to produce solid filaments in a vacuum at first a gas is liquefied and subsequently the liquefied gas is injected via a nozzle into the vacuum, the liquefaction of the gas being associated with an adjustment of the state variables of the liquid, that are selected in such a manner that the liquid is converted into the solid aggregate state after leaving the nozzle by the relaxation in the vacuum and the associated cooling off. The state variables comprise the pressure and the temperature of the liquid. They determine a p-T operating point in the liquid range of the phase diagram that is selected in the immediate vicinity of the liquid-solid phase boundary. In distinction to the conventional condensation liquefaction, according to the invention a predetermined operating point of the liquid is set in a heat exchanger device at which operating point the liquid forms a collimated and stable jet in the solid aggregate state after exiting from the nozzle. The jet is a straight, filamentary structure in the solid aggregate state (filament) that continues without decay in the vacuum. The free jet is stable in time and in space.

The length of the jet, that is liquid at first, in the vacuum (or the duration of the liquid state) can be advantageously adjusted in a certain manner and minimized or even reduced to almost zero by adjusting the operating point. As a consequence, the cross-sectional form of the liquid jet given by the shape of the nozzle is impressed directly onto the freezing liquid forming the solid filament. Non-reproducible jet widenings that occur in the case of conventional liquid injections in a vacuum are avoided.

The transition into the solid aggregate state takes place by adjusting the operating point, advantageously with great speed. It can be observed as a sharp boundary at a distance from the nozzle that is also designated as the freezing length. Irregularities in the solid state due to any fluctuations still present in the liquid state are suppressed. The transition into the solid aggregate state preferably takes place immediately after the exiting of the liquid out of the nozzle. The freezing length is shorter than the decay length of the liquids.

In general, the adjustment of the predetermined p-T operating point of the liquid comprises the adjusting of pressure values and/or temperature values. There is basically the possibility at a certain temperature in the heat exchanger device of adjusting the desired operating point via the pressure of the gas flowing in via the supply line or correspondingly via the flow rate of the liquid through the heat exchanger device. However, according to a preferred embodiment of the invention the adjustment of the predetermined p-T operating point comprises a temperature adjustment. The adjustment of an operating point temperature T₀ in the heat exchanger device in such a manner that the liquid passes after exiting from the nozzle directly into the solid state can take place in particular as a function of the flow rate in the heat exchanger device. If the liquid-solid phase boundary in the phase diagram takes place substantially independently of the pressure under practically interesting conditions, as is the case, e.g., with xenon, the temperature adjustment can advantageously take place independently of the flow rate or of the pressure of the liquid.

If a pressure adjustment is additionally provided after the temperature adjustment the stability and collimation of the jet can be advantageously improved even more. The pressure adjustment makes possible a fine adjustment of the desired operating point.

If the temperature- and pressure conditions of the liquid are given in the case of a concrete application, according to a further variant of the invention the adjustment of the p-T operating point can take place by an adjustment of a desired line diameter of the supply line.

The adjustment of a critical temperature of the liquid that is less than 1 degree Kelvin, especially 0.5 degree, e.g., one tenth or a few tenths above the triple point of the liquid is especially preferred. This advantageously avoids a premature freezing of the liquid in the heat exchanger device, the conditions for the formation of ice in the free jet being realized in an advantageous manner as soon as the liquid is relaxed after exiting from the nozzle.

According to another preferred embodiment of the invention the tempering of the liquid takes place while it flows through a supply line. In distinction to the use of condensation containers in conventional heat exchangers the liquefaction and temperature adjustment of the liquid take place in the supply line. A decelerated, careful condensation of the inflowing gas is advantageously achieved so that undesired oscillations due to a retardation of boiling can be avoided. The temperature adjustment for the selection of the desired p-T operating point can take place taking into account a temperature gradient possibly occurring up to the nozzle. For example, a slight warming can take place between the heat exchanger device and the nozzle that is compensated to the extent possible during the temperature adjustment in the heat exchanger device. Since this is possible only to a limited extent in particular during a cooling close to the triple point of the liquid, according to the invention the interval between the heat exchanger device extending along the supply line and between the nozzle is kept as small as possible. According to a preferred embodiment of the invention the heat exchanger device extends along the supply line up to the nozzle that can be integrated into the heat exchanger device order arranged directly adjacent to it. Accordingly, the temperature of the liquid adjusted in the heat exchanger device is substantially equal to the temperature of the liquid in the nozzle so that the p-T operating point of the liquid can be advantageously adjusted with increased accuracy.

The liquefaction along the supply line can be realized with different types of heat exchanger devicees such as, e.g., with heat exchanger devicees in which a cooling takes place by supplying a cooling medium or on the basis of the thermoelectric effect. The temperature adjustment in accordance with the invention takes place in an especially preferred manner with a liquid cooling medium. When a gaseous cooling medium is used, locally undesired temperature gradients can occur that cause a local freezing or a local bubble formation. On the other hand, the use of a liquid cooling medium makes possible a more homogeneous temperature adjustment in the heat exchanger device. Undesired local temperature gradients are excluded. This makes it possible that the liquid can be cooled as closely as possible to the desired operating point, especially to the triple point.

If the temperature of the cooling medium in the heat exchanger device is adjusted with a thermostat, this can result in further advantages for the accuracy of the adjustment of the p-T operating point. The use of a thermostat means that the temperature of the cooling medium can be set to a fixed value. In contrast to conventional liquefaction devicees in which a cooling and, in order to avoid a freezing of the liquid, a counterheating take place on the condensation container in such a manner that constant temperature variations are produced in time and space, the invention provides a thermostating under whose action the desired operating point can be adjusted with great accuracy and stability in time.

If mechanical oscillations can be caused by the thermostat operation, e.g., by compressors, then a decoupling of oscillations between the thermostat and the nozzle arrangement preferably takes place. The thermostat is preferably operated separated spatially from a vacuum chamber with the nozzle arrangement and is connected to the heat exchanger device via cooling medium lines in the course of which undesired mechanical oscillations can be dampened.

Particular advantages for the accurate and stable adjustment of the p-T operating point of the liquid can result if the temperature of the cooling medium is adjusted with at least one of the following control circuits. According to a first variant a temperature measuring can take place in the heat exchanger device with at least one temperature sensor. The measured temperature can be compared with given reference values. Upon a deviation, the supplying and/or temperature of the cooling medium can be controlled. According to a second variant an optical detection of the free jet of the tempered liquid exiting into the vacuum and especially of the freezing length of the jet can be provided. In this instance the regulating of the supplying and/or temperature of the cooling medium can take place as a function of the result of the optical measurement of the spatial phase boundary forming in the vacuum between the liquid jet and the solid filament.

The p-T operating point of the liquid is preferably adjusted in such a manner that the freezing length of the liquid is less than 10 mm, especially preferably less than 5 mm.

In general, the nozzle through which the liquid exits into the vacuum can be formed by the end of the supply line. However, according to a particularly preferred embodiment of the invention a separate nozzle (nozzle head) is provided in which the liquid is subjected to a jet formation. The jet formation comprises the forming (or stabilizing) of a certain flow profile in the jet and/or the adjusting of a certain cross-sectional profile of the liquid jet. In particular, a tapering of the cross-sectional profile is provided. For a turbulence-free exiting of the liquid, a contraction of the cross section of the flow takes place in the nozzle head in the direction of flow in which the liquid passes through an inside contour of the nozzle head that is inwardly curved and convex toward the middle.

A particular advantage of the method of the invention is that it is not limited to a certain target material, e.g., for radiation sources, but can be readily adapted to very different gases and liquids. For example, filaments in accordance with the invention can be produced from nitrogen, hydrogen, water or organic liquids. However, special advantages are obtained during a stable nozzle operation with the injection of liquefied noble gases such as, e.g., helium, argon, krypton or xenon. The invention is implemented especially preferably with liquefied xenon since it is very effective in the plasma-based generation of radiation.

As concerns the device, the objective cited above is solved by providing a nozzle arrangement, especially for producing solid filaments in a vacuum with a heat exchanger device for the liquefaction of gas and with a supply line with a nozzle, wherein the p-T operating point of the liquefied gas cited above can be adjusted with the heat exchanger device. The use of the heat exchanger device for adjusting a predetermined p-T operating point of the liquid has the advantage that the nozzle arrangement can be compactly constructed and is compatible with the vacuum chambers provided for typical applications of the invention such as, e.g., vacuum chambers of radiation sources or mass spectrometers. The heat exchanger device forms an adjustment device with which at least one state variable of the flowing liquid can be controlled in a predetermined manner.

If the heat exchanger device extends along the supply line of the gas in accordance with a preferred embodiment of the nozzle arrangement of the invention the above-cited advantages for a particularly protective and vibration-free liquefaction result. It is especially preferred to provide a heat exchanger device in which the nozzle head is integrated or that extends up to the nozzle head since in this instance the operating point of the liquid exiting from the nozzle head can be adjusted with particular accuracy. Further advantages result for a homogenous, interruption-free liquefaction in the supply line.

If the supply line runs in a wound fashion, e.g., helically through the heat exchanger device with a cooling medium, this can be advantageous for an especially compact construction of the nozzle arrangement. Alternatively, the supply line can have a straight form.

The heat exchanger device of the nozzle arrangement of the invention is preferably a counterflow cooler to whose downstream end a cooling medium is supplied and at whose upstream end the cooling medium is removed again. As a result of the counterflow principle a uniform temperature adjustment is achieved in the heat exchanger device.

The heat exchanger device of the nozzle arrangement of the invention preferably comprises a cylindrical container through which the supply line runs and in which the cooling medium is arranged. For example, a tubular cooling jacket is provided that is closed on one end facing the vacuum by the nozzle and on the opposite end by a connection plate for passing gas and cooling medium lines through.

Advantages for an elevated flexibility when using the nozzle arrangement can result if the nozzle head is arranged so that it can be dismounted or with a variable dispensing direction on the cooling jacket and/or the entire heat exchanger device can be arranged with a variable dispensing direction, e.g., in a tiltable or pivotable manner, on a vacuum chamber. In these instances the nozzle arrangement can be readily adapted to various tasks and liquids.

The compatibility with the available vacuum technology can be improved if the cooling jacket of the heat exchanger device is provided with a fastening device suitable for being fixed pressure tightly to the nozzle arrangement on a vacuum flange of a vacuum chamber.

According to an especially preferred embodiment of the invention the heat exchanger device is connected to a thermostat. In this instance advantages for the adjusting of a certain cooling medium temperature can result. Temperature gradients in time and space such as occur in conventional liquefiers with counterheating are avoided. The thermostat is preferably arranged in such a manner that its oscillations are decoupled from the heat exchanger device in order that an effect of mechanical oscillations, produced during the operation of the thermostat, on the liquefaction of gas is suppressed to the extent possible. To this end, the thermostat is connected via cooling medium lines to the heat exchanger device and positioned separately from the vacuum chamber. If the cooling medium lines are thermally insulated and run, e.g., in a vacuum-insulated manner through a vacuum hose, a heat loss along the lines is advantageously avoided and the accuracy of the temperature adjustment increased.

Further advantages of the invention can result if the nozzle arrangement is provided with a temperature- or vapor pressure sensor in the heat exchanger device and/or with an optical measuring device for monitoring in particular the exit opening of the nozzle. These measuring devices simplify making the above-cited control circuits available for stabilizing the cooling medium temperature.

If according to a further modification of the nozzle arrangement the nozzle has a convex inside contour, this can result in advantages for the formation of the jet of the exiting liquid. The liquid flows substantially turbulence-free from the nozzle head and passes in this stabilized state immediately after entering into the vacuum into the solid state.

The nozzle is preferably connected via a seal with high thermal conductivity to the end of the supply line. This reduces temperature gradients between the supply line in the heat exchanger device and between the nozzle head. The seal preferably consists of an alloy of copper and beryllium or of brass.

In order to avoid a reflux of the liquefied gas solely under the action of capillary forces a pore filter can be provided in the supply line.

The invention has the following further advantages. The nozzle arrangement forms a compact, temperature-stable high-pressure nozzle system that can operate in a temperature range of 2 K to 600 K. The filaments frozen in a vacuum can be produced with a length of at least 10 cm, in particular at least 20 cm and with a diameter in a range of 10 μm to 100 μm. This achieves a significantly enlarged distance of the focus of the laser radiation on the frozen filament from the nozzle head, especially for generating X-ray- or UV radiation. The erosion of the nozzle head is avoided or delayed so that the service life of the radiation source is lengthened. Furthermore, filaments with an extremely high directional stability are produced.

Another advantage of the invention is that it makes possible an operation of the nozzle arrangement with different, especially horizontal or vertical dispensing directions. In particular, solid filaments can be injected horizontally or vertically upward into a vacuum chamber with the nozzle arrangement of the invention.

The solidification along a path length less than 5 mm in the vacuum can be achieved by adjusting the p-T operating point of the liquid. For example, the solidification of xenon takes place already after a path length of 1 to 2 mm. This purposeful solidification immediately after the nozzle head can not be achieved with conventional nozzles.

Another advantage of the nozzle arrangement of the invention consists in the small diameter of the cooling jacket of the heat exchanger device. Sufficient space can be made available around the nozzle in order to achieve the highest possible average free path length of the evaporated particles. A rapid evaporation and therewith a rapid cooling off of the liquid can be supported with a high pump rate. Furthermore, the smaller the diameter is, the larger the angular range of the operating area accessible to the particular experiment can be selected. The nozzle arrangement can be readily changed as concerns the insertion length in the vacuum.

Further advantages and details of the invention are apparent from the description of the attached drawings.

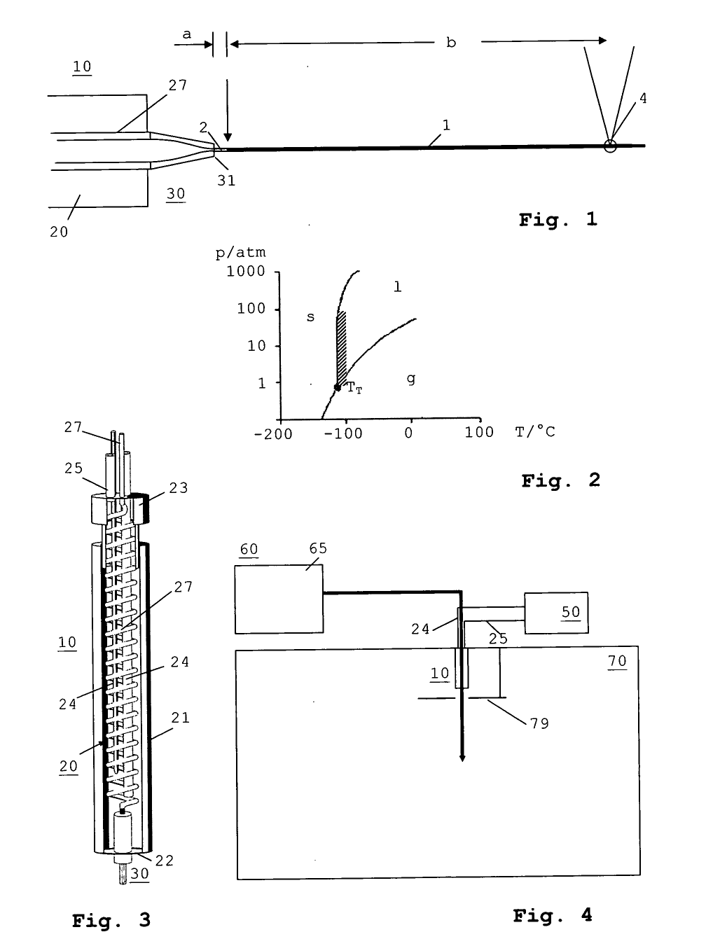

FIG. 1 shows a schematic illustration of the adjustment of the operating point of a liquid injected in accordance with the invention into a vacuum.

FIG. 2 shows a phase diagram of xenon.

FIG. 3 shows a schematic perspective view of a preferred embodiment of the nozzle arrangement of the invention.

FIG. 4 shows a schematic view of the attaching of a nozzle arrangement of the invention to a vacuum chamber.

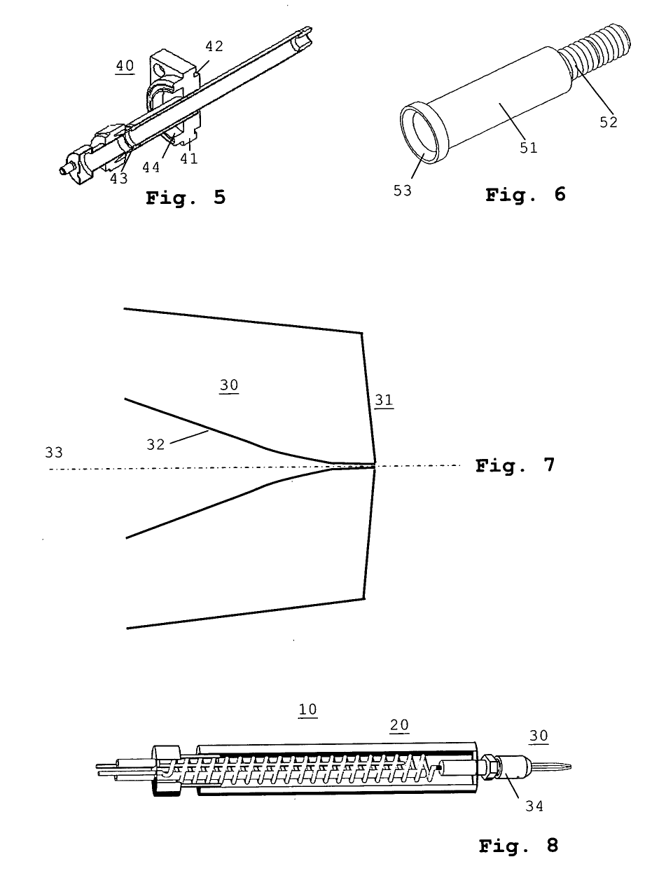

FIGS. 5 and 6 show further details of the nozzle arrangement according to FIG. 3 and its connection to a thermostat.

FIG. 7 shows an enlarged sectional view of a nozzle used in accordance with the invention.

FIG. 8 shows a schematic perspective view of another embodiment of the nozzle arrangement of the invention.

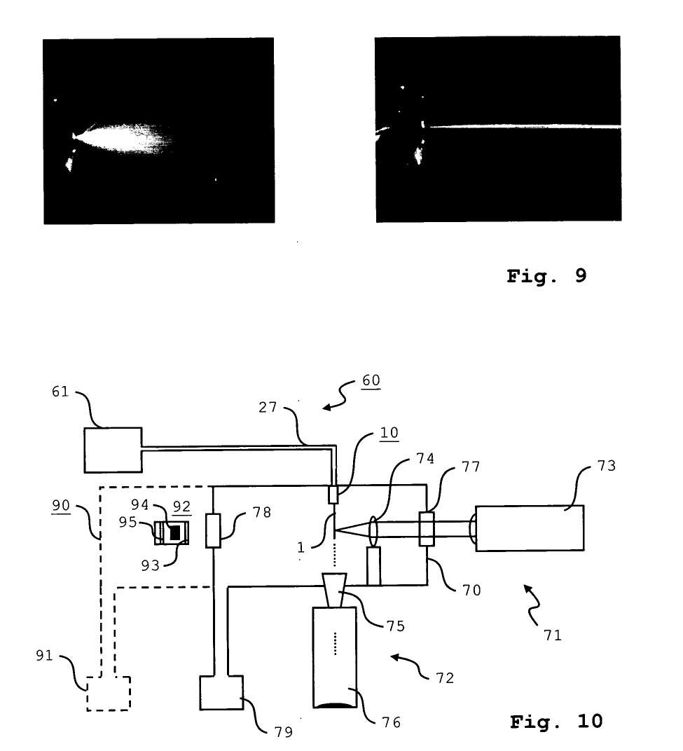

FIG. 9 shows photographs illustrating essential advantages of the invention.

FIG. 10 shows a schematic illustration of an X-ray source provided with a nozzle arrangement of the invention.

Embodiments of the invention are described in the following with exemplary reference to the production of xenon filaments in the vacuum chamber of an X-ray radiation source. The implementation of the invention is not limited, however, to this application but rather is also possible with other target materials, jet- and filament dimensions, sources for other radiation types and other technical applications.

Referring to FIGS. 1 and 2, at first thermodynamic considerations on the implementation of the invention into practice are explained. FIG. 1 shows a schematic sectional view of the free end of nozzle arrangement 10 extending into a vacuum and with heat exchanger device 20 extending along a supply line 27, and with a nozzle formed by a nozzle head adjacent to supply line 27. In order to produce a solid filament 1, e.g., as target material for the generation of X-ray radiation, a gas is liquefied in heat exchanger device 20 and the liquid is introduced through nozzle head 30 into the vacuum. At first, a free liquid jet 2 is formed. Upon exiting out of nozzle head 30 the liquid experiences a reduction of pressure (relaxation). During the exiting into the vacuum a vaporization begins from the surface of liquid jet 2, whose temperature drops due to the vaporization cooling. As soon as the temperature drops below the freezing point of the liquid the transition into the solid aggregate state follows (see arrow). An essential feature of the invention is that the state variables of the liquid in supply line 27 are adjusted to a p-T operating point in such a manner that interval a (freezing length a, see FIG. 1) of the solidification point from exit end 31 of nozzle head 30 is adjusted to be smaller than the decay length of the liquid, preferably minimized and reduced to almost zero.

Reference is made to the phase diagram of xenon, shown by way of example in FIG. 2, in order to explain the adjustment of the p-T operating point. The phase diagram illustrates the solid (s), liquid (I) and gaseous (g) states as a function of the state variables pressure (p) and temperature (T). The curve branches in the phase diagram represent the phase boundaries and are based on triple point T_{T}. According to the invention the p-T operating point of the liquid is adjusted in the shaded area of the liquid aggregate state in which the transition into the solid state is achieved by a slight temperature reduction. The liquid-solid transition for xenon and other target materials of interest advantageously takes place in the pressure range of interest substantially independently of pressure (vertical course of the s-I branch above triple point T_{T}) or with a slight pressure dependency. This facilitates providing the desired p-T operating point at first exclusively via the temperature adjustment with heat exchanger device 20 and subsequently optionally also realizing a fine adjustment for the collimation of the jet by adjusting the operating pressure (pressure at which the gas is introduced into the supply line).

The operating point temperature T₀ adjusted with heat exchanger device 20 in the liquid flowing through supply line 27 is selected as follows with a slight temperature difference above triple point T_{T}. On the one hand, the temperature difference must be selected to be sufficiently large in order to avoid an undesired freezing-out due to thermodynamic fluctuations in the nozzle head already and sufficiently small in order to adjust freezing length a (see FIG. 1) below, e.g., 5 mm, wherein a temperature gradient is also to being taken into consideration that can develop between heat exchanger device 20 and exit end 31 of nozzle head 30. In the case of xenon the adjusted operating point temperature is in the area of 161.5 K to 165 K. In general, a cooling of the liquid to fractions of a degree K is realized at the triple point (e.g., less than 1 degree).

The flow rate of the liquid in the supply line at a operating pressure of approximately 1 bar is approximately 10 m/s and at a operating pressure of approximately 100 bar approximately 100 m/s. A flow rate of approximately 50 m/s is typically adjusted.

Furthermore, it is important for an accurate and stable adjustment of freezing length a that operating point temperature T₀ is adjusted with great accuracy and stability in time. To this end the necessary cooling performance in heat exchanger device 20 and therewith the desired temperature and flowthrough amount of the cooling medium can be determined on the basis of the thermodynamic properties, known from tabular compilations, of the liquid to be injected and of the materials of the nozzle arrangement and from the operating parameters of the nozzle arrangement such as, in particular, the volumetric flow of the liquid through nozzle arrangement 10 and from the length of supply line 27 along heat exchanger device 20. These variables are selected in an especially preferred manner so that after the passage through the heat exchanger device the temperature difference between the liquid and the cooling medium substantially disappears. In this instance the adjusted temperature is independent of the flow rate in the line and the stability of the temperature adjustment improved.

For example, the volumetric or mass flow of the liquid in supply line 27 can be calculated with Bernoulli's laws from the operating pressure of the nozzle arrangement (pressure of the supplied gas) and from the diameter of supply line 27. At an operating pressure of p=40 bar a volumetric flow of 1.53 cm³/s and a mass flow of 4.6 g/s result at a jet cross section of 200 μm. Accordingly, a volumetric flow of 0.0153 cm³/s and a mass flow of 0.046 g/s result for a jet cross section of 20 μm. The amount of heat to be removed from heat exchanger device 20 for cooling the gas flow supplied at first, for its condensation and finally for adjusting the operating point temperature can be determined from the volumetric or mass flow and the thermodynamic properties of the work material. A necessary cooling performance of approximately 110 W results for xenon for the liquefaction per gram and second. Approximately 15 W are required for generating a xenon jet with a diameter of 30 μm.

For an exact cooling of the liquid to the operating point temperature the geometric parameters of heat exchanger device 20 and of supply line 27 running into it are preferably optimized on the basis of the following considerations. The temperature difference between the flowing liquid and the wall temperature of the supply line is a function in particular of the length of the supply line through which the flow passes and of the volumetric flow of the liquid. After a characteristic length L_{1/2}=vol.·σ·cₚ·λ⁻¹·0.053 the temperature difference (vol.: volumetric flow, σ: mass density, cₚ: specific heat, λ: thermal conductivity) is halved. For xenon, a half-value cooling length of approximately 16 cm results for a jet diameter of 32 μm and at a operating pressure of 40 bar. In order to adjust the relative temperature deviation less than 1% the length of the supply line in the heat exchanger device is adjusted according to a multiple of the half-value cooling length. This variable, also designated as heat exchanger length, is preferably at least 5 times and especially preferably at least 10 times longer than the half-value cooling length L_{1/2}. For xenon a relative temperature deviation that is less than 0.2 K results for the desired cooling around approximately 100 K with the indicated exemplary values and a heat exchanger length of approximately 80 cm. This can be a decisive advantage for precision applications of the invention in comparison to conventional nozzle systems.

Analogous estimations result in a heat exchanger length for argon as target material that is approximately one fourth of the heat exchanger length for xenon. The heat exchanger length increases linearly with the desired mass flow of the gaseous target material. A heat exchanger length of approximately 8 m would be required for a 200 μm xenon jet.

Finally, the adjustment of the temperature in the cooling medium in heat exchanger device 20 can take place taking into account the thermal conductivity properties of the wall material of the supply line. The thickness of the wall material is selected in consideration of a sufficient resistance to pressure and to a good heat transfer to be, e.g., 0.5 mm.

The thermodynamic considerations illustrated here show that the adjustment of the p-T operating point for a minimizing of freezing length a can be derived with sufficient accuracy solely from material dimensions and operating parameters of the nozzle arrangement. According to preferred embodiments of the invention an alternative or supplementary regulation of the operating point temperature is possible as a function of a measuring of temperature or of vapor pressure in heat exchanger device 20 or of an optical observation of the freezing length. The optical observation takes place, e.g., with a microscope whose beam path is directed through a transparent window of a vacuum chamber onto nozzle 30. Since the target material experiences substantially no further changes in the vacuum after it has been frozen, free filament length b can be considerably increased. The focusing of laser beam 4 onto filament 1 takes place, e.g., with a filament length b of 20 cm.

A preferred embodiment of nozzle arrangement 10 of the invention is illustrated with more details in FIG. 3. Nozzle arrangement 10 comprises the heat exchanger device 20 and nozzle head 30. Heat exchanger device 20 comprises a cooling medium container formed by cooling jacket 21 that is closed on its free end 22 on the vacuum side by a front wall and nozzle head 30 and on its opposite end by closure plate 23. The container serves to receive a cooling medium that is supplied by a first cooling medium line 24 and can be removed by a second cooling medium line 25. Cooling medium lines 24, 25 are connected to a thermostat 50 (see FIG. 4). In order to realize a counterflow cooler the first cooling medium line 24 extends up to free end 22 of the cooling jacket whereas the second cooling medium line 25 ends at connection plate 23.

Temperature sensor 24 is arranged in heat exchanger device 20, whose sensor signals can be diverted to the outside via a connection line through connection plate 23.

Supply line 27 for the target material extends helically from connection plate 23 to nozzle head 30. Supply line 27 is a capillary with an inside diameter of 1/16 (corresponding approximately to 0.16 mm).

Cooling jacket 21 consists, e.g., of high-grade steel. It has an inside diameter of approximately 12 mm. The length of the cooling jacket can be selected as a function of the desired heat exchanger length of supply line 27 and is approximately 17 cm or 40 cm. The supply line consists of an inert material, e.g., high-grade steel or titanium and has a wall thickness of approximately 0.5 mm.

Nozzle head 30, that is explained below with further details and with reference made to FIG. 7, is connected via a seal with high thermal conductivity and consisting preferably of a Cu—Be alloy to the end of supply line 27.

FIG. 4 shows the attaching of nozzle arrangement 10 of the invention to the wall of vacuum chamber 70. Cooling medium supply and removal lines 24, 25 run to thermostat 40. Supply line 27 is connected to reservoir 61 of target source 16.

According to the invention the nozzle arrangement can be equipped with a screening device arranged for thermal insulation in front of nozzle 30 in the exiting direction. A heat shield or screen shield 35 consisting, e.g., of steel or graphite is provided as a diaphragm with a passage opening for filament 1. Screen shield 35 is arranged between the irradiation site (focus 4 of the laser, see FIG. 1) and nozzle 30 and is fastened, e.g., on the wall of vacuum chamber 70. It suppresses an undesired heating of the nozzle and improves the rigid coupling of the nozzle temperature to the temperature in the heat exchanger. The interval of screen shield 35 from nozzle 30 is, e.g., 5 cm.

The alignment of nozzle arrangement 10 can be selected to deviate from the vertical direction with the exit from above downward. In particular, a horizontal alignment or a vertical alignment with the exit from below upward (“overhead arrangement”) can be provided. In this instance in order to avoid an undesired reflux through the supply line a wire bundle or a pore filter can be provided in the latter that has a wick effect. The wire bundle consists, e.g., of pieces of wire with a length of 10 mm and a diameter of 10 μm.

Nozzle arrangement 10 is equipped in accordance with a preferred embodiment of the invention with fastening device 40 that serves for fixing to a vacuum flange of vacuum chamber 70 and is shown with more details in FIG. 5. Fastening device 40 has laterally circumferential collar 41. Circumferential groove 42 is provided on one side of collar 41 for receiving a seal during the attachment of fastening device 40 to the connection flange. Collar 41 has stay tube 43 on the opposite side to which cooling jacket 21 of heat exchanger device 20 can be tightly and detachably connected, and has projection 44 with an outer threading for attaching screen casing 44 of the cooling medium lines (see FIG. 6). The connection of cooling jacket 21 to stay tube 43 takes place by a squeeze screw coupling with readily exchangeable, known plastic seals or metallic cutting rings resistant to high and low temperatures.

A particular advantage of fastening device 40 is that nozzle arrangement 10 can be rapidly mounted or dismounted with slight expense. This is especially significant in applications in production cycles in practice when replacing nozzle heads. A replacement of a nozzle arrangement of the invention including the necessary thawing and cooling times advantageously lasts only approximately 30 minutes.

Thermostat 50 is a known, commercially available circulatory cryostat. The cooling medium is moved with a circulating pump via cooling medium supply line 24 into heat exchanger device 20 and back to the cryostat via cooling medium removal line 25. For example, isopentane is used as cooling medium, that is especially advantageous for the nozzle operation in the range of −130° C. to 0° C. Alternatively, e.g., methane or a cold gas such as, e.g., nitrogen vapor or helium vapor can be used. Cooling medium lines 24, 25 are thermally insolated by casing 51 and flexible vacuum jacketing 52 (see FIG. 6). This avoids energy losses along the lines and improves the adjustment of the operating point temperature in the heat exchanger device. Furthermore, precipitations from the ambient air on lines 24, 25 are advantageously avoided. Casing 51 can be connected via the screw threading (at 53) to projection 44 of fastening device 40 (see FIG. 5).

The spatial separation of nozzle arrangement 10 and thermostat 50 has the additional advantage that oscillations caused by the operation of the thermostat are damped. For this reason cooling medium supply and removal lines 24, 25 preferably have a length of at least 1 m.

FIG. 7 illustrates exit end 31 of nozzle 30 in an enlarged sectional view. Nozzle 30 has a tapering, constant inner contour 32 curved convexly inward. An angle of inclination of inner contour 32 to nozzle axis 33 is preferably selected that is smaller than 45° for a turbulence-free exiting of the liquid jet from nozzle 30. Nozzle 30 consists, e.g., of quartz glass or another inert, low-corrosion material. The diameter at the exit end is approximately 20 to 60 μm.

In order to produce solid filaments 1 in vacuum chamber 70 in accordance with the invention a start phase in which the gaseous target material flow from reservoir 61 under pressure through nozzle arrangement 10 takes place at first while the latter is being cooled. As soon as the cooling in heat exchanger device 20 is sufficient to liquefy the target material, liquid jet 2 is injected into vacuum chamber 70. The further temperature adjustment to the desired operating point temperature can take place by measuring the temperature in the heat exchanger device and by a corresponding controlling of the cooling medium temperature on the cryostat and/or the optical observation of the freezing length (see FIG. 1).

A modified embodiment of nozzle arrangement 10 of the invention is illustrated with further details in FIG. 8. Nozzle arrangement 10 comprises heat exchanger device 20 and nozzle head 30 connected, e.g., screwed via an additional intermediate piece 34 to heat exchanger device 20 and supply line 27. Intermediate piece 34 facilitates the exchangeability and optionally the adjustability of nozzle 30. The remaining details correspond to the design of FIG. 3.

Intermediate piece 34 can be bent and the exit direction of the nozzle relative to the axis of the cooling jacket can be bent, e.g., 90°. In this instance advantages can result for a simplified insertion of a nozzle arrangement into a vacuum chamber.

A bellows connection can be provided between nozzle 30 or intermediate piece 34 and the cooling jacket. The bellows connection, that is, e.g., a part of the cooling jacket, makes possible a flexible adjustment of the exit opening of the nozzle. Capillary-shaped supply line 27 can advantageously follow such an adjustment on account of its flexibility.

FIG. 9 illustrates the advantages of the invention with the example of images of the exit end of the nozzle taken with a microscope. In the conventional technology (without adjustment of the desired operating point) the jet decays into irregular partial flows extending like a spray into the chamber (left image). According to the invention the stable jet is produced that extends into the vacuum without decay (right image). The phase boundary can be recognized immediately after the exit end of the nozzle.

FIG. 10 schematically illustrates an example of an X-ray source in accordance with the invention. The X-ray source comprises target source 60 connected to vacuum chamber 70 capable of being tempered, irradiation device 71 and collection device 72.

Target source 60 comprises reservoir 61 for a target material, supply line 27 and nozzle arrangement 10 in accordance with the invention that is connected to the thermostat (not shown). The target material is conducted to nozzle arrangement 10 with an actuating device (not shown) comprising, e.g., a pump or a piezoelectric transport device and is injected from this nozzle arrangement 10 into vacuum chamber 70 as described above.

Irradiation device 71 comprises radiation source 73 and irradiation optics 74 with which radiation from radiation source 73 can be focused on target material 1. Radiation source 73 is, e.g., a laser whose light is guided, if necessary, with the aid of deflection mirrors (not shown) to target material 1. Alternatively, an ion source or an electron source also arranged in vacuum chamber 70 can be provided as irradiation device 71.

Collection device 72 comprises receiver 75, e.g. in the form of a funnel or a capillary that removes the target material not vaporized under the action of the irradiation from vacuum chamber 70 and conducts it into collection container 76.

Vacuum chamber 70 comprises a housing with at least a first window 77 through which target material 1 can be irradiated, and at least a second window 78 through which the generated X-ray radiation exits. Second window 78 is optionally provided in order to decouple the generated X-ray radiation from vacuum chamber 70 for a certain application. If this is not required, second window 78 can be dispensed with. Furthermore, vacuum chamber 70 is connected to vacuum device 79 with which a vacuum is produced in vacuum chamber 70. This vacuum is preferably below 10-5 mbar. Irradiation optics 74 is also arranged in vacuum chamber 70. If vacuum device 79 is a cryopump, undesired mechanical oscillations in the vacuum chamber are advantageously avoided.

Second window 78 consists of a window material that is transparent for soft X-ray radiation, e.g., beryllium. If second window 78 is provided, it can be followed by evacuatable processing chamber 90 connected to another vacuum device 91. The X-ray radiation can be reproduced on an object in processing chamber 90 for material processing. For example, X-ray lithography device 92 is provided with which the surface of a semiconductor substrate is irradiated. The spatial separation of the x-ray source in vacuum chamber 70 and of X-ray lithography device 92 in processing chamber 90 has the advantage that the material to be processed is not exposed to deposits of vaporized target material.

X-ray lithography device 92 comprises, e.g., filter 93 for selecting the desired X-ray wavelength, mask 94 and substrate 95 to be irradiated. In addition, reproduction optics (e.g., mirrors) can be provided for guiding the X-ray radiation onto X-ray lithography device 91.

The invention is not limited to the preferred exemplary embodiments described above but rather a plurality of variants and modifications is possible that also make use of the inventive concept and therefore fall within its protective range.

1. A method for producing a solid filament from a liquid in
a vacuum chamber, comprising:
liquefying a gas in a heat exchanger device for producing the liquid, wherein the liquefying of the gas in the heat exchanger device comprises adjusting a p-T operating point of the liquid, and
supplying the liquid via a supply line and through a nozzle into a vacuum chamber,
wherein the liquid is converted into the solid aggregate state after exiting from the nozzle into the vacuum chamber and forms a collimated and stable jet.

2. The method according to claim 1, wherein the adjustment of the p-T operating point of the liquid comprises tempering the liquid in the heat exchanger device to an operating point temperature T₀ below which the liquid becomes solid.

3. The method according to claim 1, wherein the adjustment of the p-T operating point of the liquid comprises a tempering the liquid in the heat exchanger device to an operating point temperature T₀ that is less than 1 degree above the triple point T_{T} of the liquid.

4. The method according to claim 1, wherein the tempering of the liquid takes place while it flows through the supply line.

5. The method according to claim 4, wherein the tempering of the liquid takes place along the supply line up to the nozzle.

6. The method according to claim 1, wherein a temperature gradient is formed along the supply line in the heat exchanger device that is less than 2 degrees/cm.

7. The method according to claim 1, wherein the tempering takes place in the heat exchanger device with a liquid cooling medium.

8. The method according to claim 7, wherein the temperature of the cooling medium is adjusted with a thermostat.

9. The method according to claim 7, wherein a temperature or a vapor pressure of the cooling medium is measured in the heat exchanger device.

10. The method according to claim 1, wherein an optical measuring of the liquid exiting into the vacuum chamber takes place.

11. The method according to claim 1, wherein at least one of gas pressure, supply volume of the cooling medium and temperature of the cooling medium in the heat exchanger device is adjusted as a function of the result of a temperature measurement, a vapor pressure measurement or an optical measurement.

12. The method according to claim 11, wherein a control circuit is formed for adjusting the at least one parameter.

13. The method according to claim 1, wherein the liquid in the nozzle is subjected to a jet formation.

14. The method according to claim 1, wherein the supplied gas is a noble gas.

15. The method according to claim 14, wherein the supplied gas is xenon.

16. The method according to claim 1, wherein the p-T operating point of the liquid is selected in such a manner that the liquid becomes solid after exiting from the nozzle within a freezing length (a) that is less than 10 mm.

17. A nozzle arrangement for producing solid filaments in a vacuum, comprising:
a heat exchanger device for producing a liquid from a gas,
wherein the heat exchanger device is adapted for adjusting a p-T operating point of the liquid such that the liquid can be converted after exiting from the nozzle into a vacuum into a solid aggregate state and a collimated and stable jet form, and
a supply line with a nozzle through which the liquid can exit into the vacuum.

18. The nozzle arrangement according to claim 17, wherein the heat exchanger device extends along the supply line.

19. The nozzle arrangement according to claim 18, wherein the heat exchanger device extends along the supply line up to the nozzle.

20. The nozzle arrangement according to claim 17, wherein the heat exchanger device extends over a length of at least 40 cm along the supply line.

21. The nozzle arrangement according to claim 17, wherein the supply line runs helically through the heat exchanger device.

22. The nozzle arrangement according to claims 17, wherein the supply line has a wall thickness in a range of 0.1 mm to 0.5 mm.

23. The nozzle arrangement according to claim 17, wherein the heat exchanger device is a counterflow cooler.

24. The nozzle arrangement according to claim 17, wherein the heat exchanger device contains a liquid cooling medium.

25. The nozzle arrangement according to claim 17, wherein the heat exchanger device comprises a tubular cooling jacket and the nozzle is arranged at an end of the cooling jacket.

26. The nozzle arrangement according to claim 25, wherein the nozzle is demountably arranged on the cooling jacket.

27. The nozzle arrangement according to claim 25, wherein the nozzle is adjustably arranged on the cooling jacket in such a manner that the orientation of a dispensing direction of the nozzle can be changed relative to a longitudinal extension of the cooling jacket.

28. The nozzle arrangement according to claim 17, wherein a screening device is provided that serves for thermal insulation of the nozzle.

29. The nozzle arrangement according to claim 25, wherein a fastening device is provided for fastening the cooling jacket to a vacuum flange.

30. The nozzle arrangement according to claim 25, wherein the heat exchanger device is connected to a thermostat with which the cooling medium in the heat exchanger device can be tempered.

31. The nozzle arrangement according to claim 30, wherein the thermostat is arranged such that it is decoupled from oscillations relative to the heat exchanger device.

32. The nozzle arrangement according to claim 30, wherein the heat exchanger device is connected via thermally insulated lines to the thermostat.

33. The nozzle arrangement according to claim 17, wherein a temperature sensor or vapor-pressure sensor is arranged in the heat exchanger device.

34. The nozzle arrangement according to claim 17, wherein the supply line opens at the nozzle with a convex inside contour into an exit opening.

35. The nozzle arrangement according to claim 17, wherein the nozzle is detachably connected to the supply line, a seal being arranged between the nozzle and the supply line which seal consists of an alloy of copper and beryllium.

36. An apparatus with a vacuum chamber and a nozzle arrangement according to claim 17 for producing a solid filament from a liquid in the vacuum chamber.

37. A method of using a nozzle arrangement according to claim 17 for producing a frozen filament with a length of at least 10 cm and a diameter in a range of 10 μm to 100.
